(19) United States
(12) Patent Application Publication
(10) Pub. No.: US 2017/0306900 A1
(43) Pub. Date: Oct. 26, 2017

(54) AIR FILTER DEVICE FOR FILTERING THE INTAKE AIR OF A COMBUSTION ENGINE, IN PARTICULAR FOR A HAND-HELD SMALL TOOL

(71) Applicant: MAKITA CORPORATION, Anjo-shi (JP)

(72) Inventor: Manfred DÖRING, Zarrentin am Schaalsee OT Neuhof (DE)

(73) Assignee: MAKITA CORPORATION, Anjo-shi (JP)

(21) Appl. No.: 15/476,458

(22) Filed: Mar. 31, 2017

(30) Foreign Application Priority Data
Apr. 26, 2016 (DE) 202016102198.7

(51) Int. Cl. F02M 35/02; F02M 35/024; B01D 46/52; B01D 45/12; F02M 35/022; B01D 50/00; F02M 35/10

(52) U.S. Cl. CPC F02M 35/0216; F02M 35/1017; F02M 35/024; F02M 35/0226; B01D 45/12; F02M 35/0223; B01D 50/002; B01D 46/52; B01D 2279/60

(57) ABSTRACT

An air filter device for filtering the intake air of a combustion engine of a hand-held small tool, in particular an angle grinder, with a pre-filter stage having at least one cyclone air filter and with a main filter stage arranged downstream, having a permeable filter body, characterized in that a pre-separation device for pre-separating contaminations in the intake air is installed upstream of the intake air in front of the cyclone air filter, wherein the pre-separation device is configured in such a way that separated contaminations can be removed from the outside of the small tool.

The present invention refers to an air filter device for filtering the intake air of a combustion engine of a hand-held small tool, in particular an angle grinder with a pre-filter stage comprising at least one cyclone air filter and with a main filter stage arranged downstream, comprising a permeable filter body.

### PRIOR ART

For example, DE 20 2013 101 173 U1 discloses an air filter device for filtering the intake air of a combustion engine of an angle grinder, and the air filter device comprises a pre-filter stage and a main filter stage. The pre-filter stage comprises two cyclone air filters, into which the intake air enters directly. Further downstream of the cyclone air filters, the intake air gets through a permeable filter body, which forms the main filter stage. The angle grinder has a hood, which is provided with lateral air inlet openings, and through these air inlet openings the intake air reaches the region below the hood and then enters the cyclone air filters.

In case the filters of the air filter device have to be cleaned, it is usually necessary to remove the hood from the angle grinder, so that for example the permeable filter body may be taken out and cleaned. A cleaning of the air filter device that is suitable for use on building sites and has to be carried out with on-site means, for example blowing out the filter body with pressurized air, often proves difficult without device-specific tools, and mistakes occur due to an operator's lack of knowledge. For example, the operator cleans the permeable filter body by not using device-specific tools to remove the hood from the angle grinder and then taking out and beating or blowing out the permeable filter body. As the permeable filter bodies are often formed as paper air filters, the paper air filter can tear from being blown out with pressurized air. If after cleaning the filter body is not correctly placed into the corresponding retainer, the separation of contaminations from the intake air can no longer be carried out correctly, and foreign material gets into the combustion engine.

In the region in front of the cyclone air filters for forming the pre-filter stage often rough contaminations are formed which, in particular under wet or moist conditions, can agglutinate. If the lumps formed there separate from time to time, they get through the cyclone air filter into the main filter stage and have to be reliably restrained by the filter body. In particular if the operator cleans the area of entry of the intake air in front of the cyclone air filters with pressurized air, larger particulate collections which have formed dust lumps can be pressed further into the device and thus can reach the cyclone air filter.

In general, angle grinders are frequently cleaned when used, as the operation of an angle grinder causes a high dust loading. However, it is a disadvantage if, for cleaning, the operator frequently has to remove at least the hood from the body of the device in order to clean the filter body of the main filter stage. In particular, the filter body can be damaged by a too frequent cleaning. On the other hand, it is a disadvantage if the operator only blows pressurized air through the air openings in the body of the device, as the larger dust lumps can separate, which can then reach the air intake area, as described before.

### DISCLOSURE OF THE INVENTION

The object of the invention is the further development of an air filter device for filtering the intake air of a combustion engine of a hand-held small tool, in particular an angle grinder, which provides an improved cleanability for removing separated contaminations.

This object is solved based on an air filter device according to the preamble of claim 1 and based on a handheld small tool according to the preamble of claim 12 with their respective distinguishing features. Advantageous further embodiments are specified in the dependent claims.

The invention includes the technical teaching that upstream of the intake air in front of the cyclone air filter a pre-separation device for pre-separating contaminations in the intake air is provided, wherein the pre-separation device is configured in such a way that the separated contaminations can be removed from the outside of the small tool.

The main concept of the invention is a further development of a separation device in addition to the pre-filter stage and the main filter stage of the air filter device. The pre-separation device should be cleanable by an operator from the exterior of the small tool, so that contaminations can be removed from the area of the pre-separation device without disassembling a part of the small tool. The advantage of the pre-separation device according to the invention is that a quick cleaning of the air filter device can be effected, which can for example be carried out with pressurized air, but for example also with water. The cleaning of the pre-separation device is not to replace the cleaning of the main filter stage with the permeable filter body, but the short-term cleaning of the pre-separation device provides a quick cleaning on-site, which for example is not carried out during an inspection of the angle grinder.

Advantageously the pre-separation device is configured as a labyrinth filter, with which the separation of the contaminations from the intake air is possible by means of at least one diversion of the intake air. Labyrinth filters have the advantage of being configured in a simple manner and not requiring replacement filter bodies. Here, an air filter device can comprise for example a hood, wherein the labyrinth filter is arranged between the hood and the cyclone air filter. It is also possible to configure the air filter device as a large cyclone air filter which is arranged behind the air inlet openings, using an appropriate moisture protection.

For the configuration of the labyrinth filter, it is for example provided that the cyclone air filter is mounted at or configured one-piece with a carrier, wherein the carrier has at least one wall element, which forms a first part of a labyrinth filter. For example, the carrier has two wall elements which are arranged parallel to each other at a distance. Further, it is advantageous if the hood has at least one wall element, which forms a second part of the labyrinth filter. In particular, the hood has two wall elements arranged parallel to each other at a distance, from which a wall element extends between or in front of the two wall elements at the carrier. By this already, a meandering shape of the flow path of the intake air through the labyrinth filter is formed, so that by means of the diversion effect, contaminations are catapulted outside and the contaminations can be collected in a respective area of the pre-separation device.

For example, a wall element forms a moisture protection at the hood against water ingressing into the area between the hood and the cyclone air filter. If the pre-separation device is for example cleaned with water, for example through slit openings in the hood, at least one wall element of the labyrinth filter prevents the further ingress of water, so that the at least one wall element forms a moisture protection. The water can be guided in such a way that it reaches a dirt collection area of the labyrinth filter, in which the contaminations accumulate. Particularly advantageously the dirt collection area is arranged between the carrier and the hood.

It is also possible that the hood has openings in the dirt collection area which are configured for removing the contaminations collected in the dirt collection area. If for example an operator blows pressurized air through the openings of the hood, the contaminations can leave the dirt collection area through the openings. The same can be achieved by using a jet of water. In a further embodiment it may be possible that the openings are formed by a dirt exhaust which is mounted in the carrier, so that during a blowing or flushing out the contaminations flow downwards below the carrier, which for example forms the filter cover. This dirt exhaust may comprise a check valve in order to prevent an unwanted ingress of moisture or contaminations.

It is also possible that the labyrinth filter is configured to be removable from the hood at least with the wall elements mounted at the hood and/or from the carrier with the wall elements mounted at the carrier.

In particular, it is advantageous if the labyrinth filter is configured as a module that can be removed from the air filter device and in particular from the hood. Thus the pre-separation device can be removed and cleaned without a further opening of parts of the small tool. The removal and replacement of the removable module should be achievable without any tools. For example, the removable module can be locked at the body of the angle grinder, with the locking being temporarily detachable by a simple operation.

A removable module with the pre-separation device is particularly advantageous if the pre-separation device is cleaned with high air pressure or with a strong jet of water, as the cleaning can take place outside the tool. The further filter stages, i.e. particularly the cyclone air filters, in the removed module can for example be closed by appropriate means.

The invention further aims at a handheld small tool with an air filter device for filtering the intake air for a combustion engine of the angle grinder, with a pre-filter stage comprising at least one cyclone air filter and with a main filter stage arranged downstream, comprising a permeable filter body, wherein a pre-separation device for pre-separating contaminations in the intake air is installed upstream of the intake air in front of the cyclone air filter, wherein the pre-separation device is configured in such a way that separated contaminations can be removed from the outside of the small tool. The features and corresponding advantages further mentioned in connection with the air filter device are also considered for the handheld small tool.

### PREFERRED EMBODIMENT OF THE INVENTION

Further measures improving the invention are shown in more detail in the following together with the description of a preferred embodiment of the invention by means of the figures. The figures show the following:

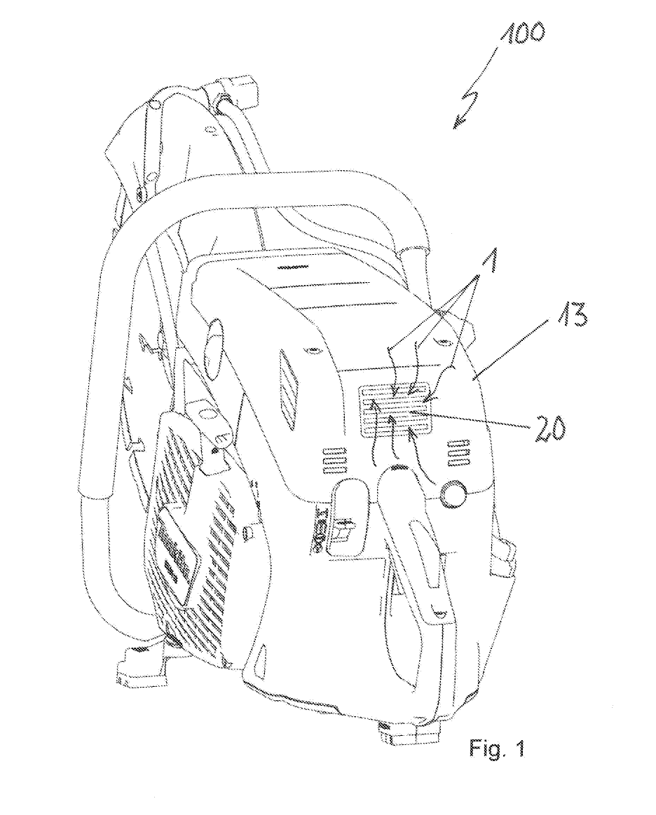

FIG. 1 a general view of an angle grinder with an air filter device according to the invention

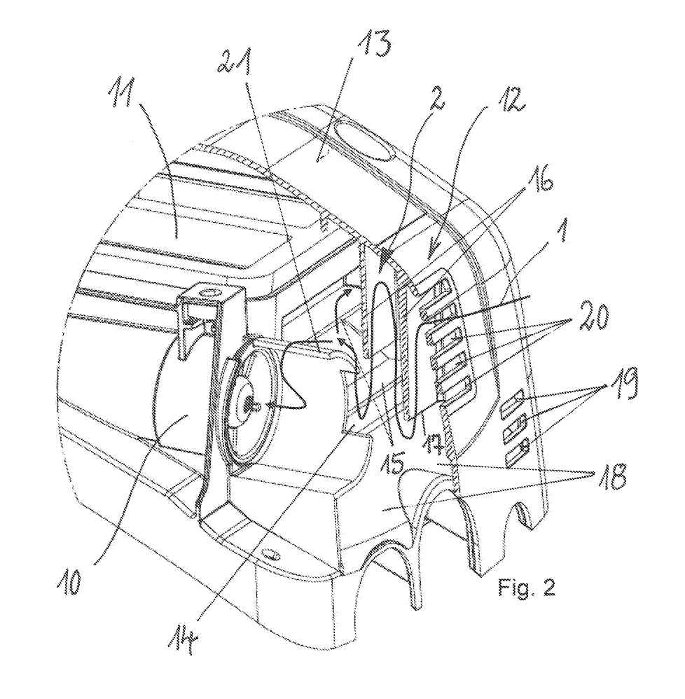

FIG. 2 a detailed view of the air filter device for filtering the intake air, wherein the hood of the angle grinder is shown in a sectional view

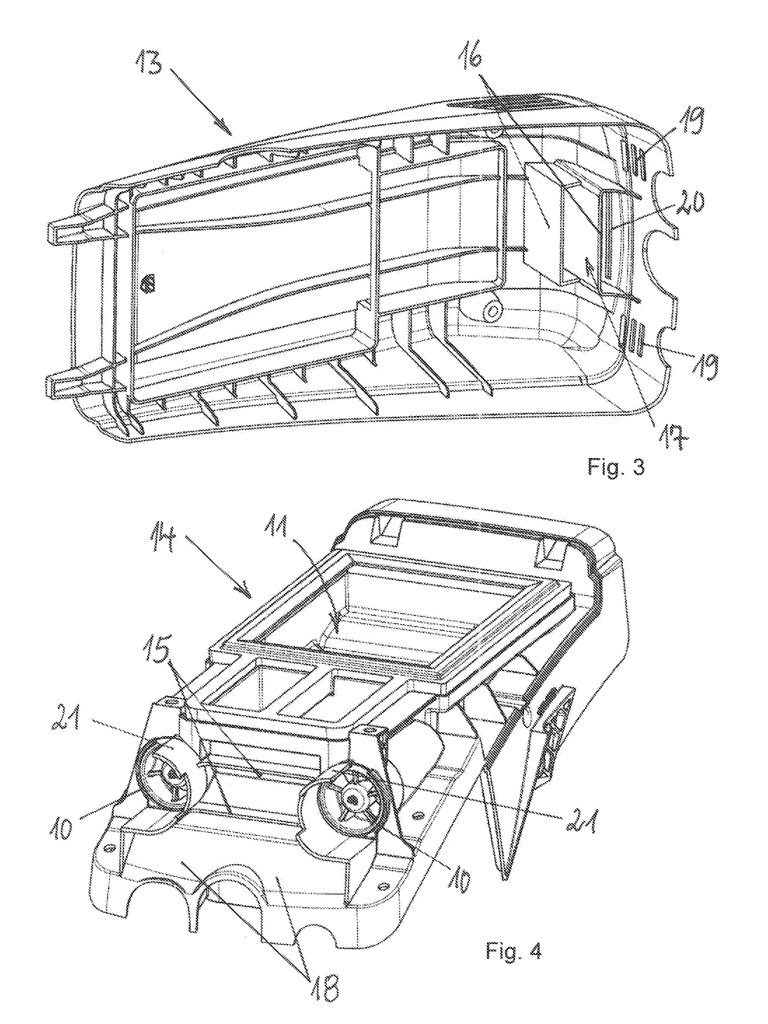

FIG. 3 a bottom view of the hood of the angle grinder and

FIG. 4 a view of the carrier of the angle grinder, at which two cyclone air filters and a device for receiving a filter body are configured.

FIG. 1 shows an angle grinder 100 as an example of a handheld small tool, which has an air filter device for filtering an intake air 1. The angle grinder 100 has a hood 13, which is configured to be removable from the remaining body of the device. In the hood 13, air inlet openings 20 are installed, through which the intake air 1 can pass.

FIG. 2 shows a sectional view through the hood 13 in arrangement at the body of the device, wherein the body of the device further comprises a core 14, which is shown in the view underneath the hood 13. If the intake air 1 enters through the air inlet openings 20, the intake air 1 reaches an area between the hood 13 and the carrier 14. At the carrier 14, cyclone air filters 10 are configured, wherein, due to the sectional view, a front cyclone air filter 10 is visible, into which the intake air 1 enters.

Between the entry area of the intake air 1 through the inlet openings 20 in the hood 13 and the cyclone air filters 10, according to the invention the pre-separation device 2 is located, which is for example configured as a labyrinth filter 12, and the pre-separation device 2 can also be configured in alternative embodiments, for example as a pre-cyclone air filter with a corresponding opening width.

The pre-separation device 2 is formed by multiple wall elements 15 and 16, wherein first wall elements 15 are configured at the carrier 14, and further wall elements 16 are configured at the hood 13.

Further, the pre-separation device 2 comprises a dirt collection area 18, which is arranged below the wall elements 15 and 16 with reference to an unusual operative position of the angle grinder. The dirt collection area 18 is formed in a space between the carrier 14 and the hood 13, and the hood 13 has openings 19 in the region of the dirt collection area 18. Through the openings 19 contaminations can be lead out of the dirt collection area 18, for example if an operator lets pressurized air or a jet of water enter through the air inlet opening 20.

The wall elements 16 at the hood 13 are configured in such a way that a front wall element 16 forms a moisture protection 17. The moisture protection 17 prevents the ingress of water entering through the air inlet openings 20 into the rear area of the air intake zone, wherein further protection elements are formed by barriers 21, which cover the entry area of the cyclone air filter 10 in a half-shell shape. Therefore, the intake air 1 has to flow around the outsides of the barriers 21, which prevents moisture, in particular water droplets, but also contaminations from being carried along into the cyclone air filter 10.

FIG. 3 shows a bottom view of the hood 13 with the wall elements 16 configured at the inner sides of the hood 13. Further shown are the openings 20 for removing the contaminations and the air inlet openings 20 for the entry of the intake air. The view shows the wall elements 16 with a front wall element, which forms the moisture protection 17.

FIG. 4 shows a view of the carrier 14 with a filter body 11 which can be inserted on the top side and with the cyclone air filters 10. Between the cyclone air filters 10 with the barriers 19, the wall elements 15 extend approximately in horizontal direction. Below the wall elements 15, the dirt collection area 18 is located, which is covered on the front side by the hood 13 (not shown).

If the hood 13 according to FIG. 3 is attached to the carrier 14 according to FIG. 4, the space between the cyclone air filters 10 is substantially closed, and the wall elements 15 and 16 getting into interaction cause the entering intake air to be diverted in a labyrinth-like manner, so that contaminations accumulate in the dirt collection area 18.

The invention is not limited to the preferred exemplary embodiment stated above. On the contrary, a number of variations are possible, which make use of the shown solution even with embodiments of a fundamentally different type. All features and/or advantages deriving from the claims, including design details, spatial arrangements and method steps, can be substantial to the invention both by themselves as well as in any combinations.

### LIST OF REFERENCE SIGNS

100 angle grinder
1 intake air
2 pre-separation device
10 cyclone air filter
11 filter body
12 labyrinth filter
13 hood
14 carrier
15 wall element
16 wall element at the hood
17 moisture protection
18 dirt collection area
19 opening
20 air inlet opening
21 barrier

1. An air filter device for filtering the intake air of a combustion engine of a hand-held small tool, in particular an angle grinder, with a pre-filter stage comprising at least one cyclone air filter and with a main filter stage arranged downstream, comprising a permeable filter body,
wherein a pre-separation device for pre-separating contaminations in the intake air is installed upstream of the intake air in front of the cyclone air filter, wherein the pre-separation device is configured in such a way that separated contaminations can be removed from the outside of the small tool.

2. The air filter device according to claim 1, wherein the pre-separation device is configured as a labyrinth filter with which the separation of the contaminations from the intake air is possible by means of at least one diversion of the intake air.

3. The air filter device according to claim 1, wherein the air filter device has a hood, wherein the labyrinth filter is arranged between the hood and the cyclone air filter.

4. The air filter device according to claim 1, wherein the cyclone air filter is mounted at or configured one-piece with a carrier, wherein the carrier has at least one wall element, which forms a first part of a labyrinth filter.

5. The air filter device according to claim 2, wherein the hood has at least one wall element, which forms a second part of the labyrinth filter.

6. The air filter device according to claim 5, wherein at least one wall element at the hood forms a moisture protection against water ingressing into the area between the hood and the cyclone filter.

7. The air filter device according to claim 1, wherein a dirt collection area is configured below the labyrinth filter.

8. The air filter device according to claim 7, wherein the dirt collection area is configured between the core and the hood.

9. The air filter device according to claim 7, wherein the hood has openings in the dirt collection area, which are configured for removing the contaminations collected in the dirt collection area.

10. The air filter device according to claim 1, wherein the labyrinth filter is configured to be removable from the hood at least with the wall elements mounted at the hood and/or from the carrier with the wall elements mounted at the carrier.

11. The air filter device according to claim 1, wherein the labyrinth filter is configured as a module that can be removed from the air filter device and in particular from the hood.

12. A handheld small tool with an air filter device for filtering the intake air of a combustion engine of the angle grinder, with a pre-filter stage comprising at least one cyclone air filter and with a main filter stage arranged downstream, comprising a permeable filter body,
wherein a pre-separation device for pre-separating contaminations in the intake air is installed upstream of the intake air in front of the cyclone air filter, wherein the pre-separation device is configured in such a way that separated contaminations can be removed from the outside of the small tool.
